(19) United States
(12) Patent Application Publication
(10) Pub. No.: US 2025/0130868 A1
(43) Pub. Date: Apr. 24, 2025

(54) PREDICTIVE HARDWARE LOAD BALANCING METHOD AND APPARATUS

(71) Applicant: Lenovo Enterprise Solutions (Singapore) Pte. Ltd., New Tech Park (SG)

(72) Inventors: Fadel Matar, Ottawa (CA); Jason Gray, Gardner, KS (US); Jerrod K Buterbaugh, Wake Forest, NC (US); Trusha Pandya, Alpharetta, GA (US)

(21) Appl. No.: 18/382,341

(22) Filed: Oct. 20, 2023

(51) Int. Cl. G06F 9/50; G06N 20/00

(52) U.S. Cl. CPC G06F 9/5083; G06N 20/00

(57) ABSTRACT

A method for predictive hardware load balancing based on user behavior is presented. The method receives, by a processor, a request from a user to access a cloud computing system. In response to the request, the method associates the user with a user profile using a learning model that uses machine learning to characterize attributes of the user and uses the attributes of the user to determine which user profile of a plurality of user profiles to associate with the user. Each of the user profiles is associated with a set of attributes and a set of system resources. The method allocates system resources to the user based on the user profile.

### FIELD

The subject matter disclosed herein relates to load balancing methods and more particularly relates to methods for predictively balancing a load.

### BACKGROUND

Similar to traditional hardware-based load balancers, load balancers in a cloud computing or hybrid cloud environment play a critical role in ensuring high performance. Load balancers aim to equally distribute workloads across multiple servers or machines, thereby preventing exhaustion of available processing resources on one server while other servers are idle or have spare capacity. In addition, load balancers attempt to balance network traffic accessing such computing resources to optimize overall cloud and/or network performance. Ideally, effective load balancing protects against service disruptions, increases overall availability and throughput, and reduces latency.

Currently available load balancers for cloud or hybrid cloud environments, however, distribute traffic and workloads based on static policies and imprecise data. As a result, current load balancers for cloud or hybrid cloud environments tend to be unreliable and inefficient.

### BRIEF SUMMARY

A method for predictive hardware load balancing based on user behavior is disclosed. An apparatus and computer program product also perform the functions of the method. In some embodiments, the method receives, by a processor, a request from a user to access a cloud computing system. In response to the request, the method associates the user with a user profile using a learning model that uses machine learning to characterize attributes of the user and uses the attributes of the user to determine which the profile of a plurality of user profiles to associate with the user. In certain embodiments, each of the user profiles is associated with a set of attributes and a set of system resources. The method allocates system resources to the user based on the user profile.

According to another aspect of the invention, an apparatus for predictive hardware load balancing includes a processor and a non-transitory computer readable storage media storing code. The code is executable by the processor to perform operations. In some embodiments, the operations include receiving a request from a user to access a cloud computing system. In some embodiments, the operations further include, in response to the request, associating the user with a user profile via a learning model. The learning model uses machine learning to characterize attributes of the user. In some embodiments, the learning model further uses the attributes of the user to determine the user profile of multiple user profiles to associate with the user. Each of the user profiles is associated with a set of attributes and a set of system resources. In some embodiments, the operations include allocating system resources to the user based on the user profile.

According to a third aspect of the invention, a program product for predictive hardware load balancing includes a non-transitory computer readable storage medium storing code. The code is configured to be executable by a processor to perform operations. In some embodiments, the operations include receiving a request from a user to access a cloud computing system and, in response to the request, associating the user with a user profile via a learning model. In some embodiments, the learning model uses machine learning to characterize attributes of the user. The learning model also uses the attributes of the user to determine the user profile of multiple user profiles to associate with the user. Each of the user profiles is associated with a set of attributes and a set of system resources. In some embodiments, the operations include allocating system resources to the user based on the user profile.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a cloud computing system for predictive hardware load balancing, according to various embodiments;

FIG. 2 is a schematic block diagram illustrating a method for predictive hardware load balancing, according to various embodiments;

FIG. 3 is a schematic block diagram illustrating another method for predictive hardware load balancing apparatus, according to various embodiments;

FIG. 4 is a schematic flow chart diagram illustrating a training phase of a method for predictive hardware load balancing, according to various embodiments;

FIG. 5 is a schematic flow chart diagram illustrating a use phase of a method for predictive hardware load balancing, according to various embodiments; and

FIG. 6 is a schematic flow chart diagram illustrating a method for predictive hardware load balancing, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “some embodiments,” “an embodiment,” or similar language means that a particular feature, structure, or characteristic described in connection with the embodiment is included in at least one embodiment. Thus, appearances of the phrases “in some embodiments,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

The description of elements in each figure may refer to elements of proceeding figures. Like numbers refer to like elements in all figures, including alternate embodiments of like elements.

As previously discussed, load balancers aim to equally distribute workloads and traffic across multiple servers or machines to optimize overall cloud and/or network performance. Currently available load balancers for cloud or hybrid cloud environments, however, distribute traffic and workloads based on static policies and imprecise data. As a result, current load balancers tend to be unreliable and inefficient. The embodiments disclosed herein address these and other issues.

A method for predictive hardware load balancing receives, by a processor, a request from a user to access a cloud computing system. In response to the request, the method associates the user with a user profile using a learning model that uses machine learning to characterize attributes of the user and uses the attributes of the user to determine the user profile of a plurality of user profiles to associate with the user. Each of the user profiles is associated with a set of attributes and a set of system resources. The method allocates system resources to the user based on the user profile. In some embodiments, the system resources include utilization of a CPU, a GPU, an accelerator, an FPGA, ROM storage, RAM storage, and/or an internet connection speed.

In some embodiments, the set of attributes includes usage data associated with system resources such as a type of resources used, a length of time the resources are used, and/or a time of day the resources are used. In certain embodiments, the learning model is configured to determine a usage data range associated with each of the attributes for each user profile. The usage data range for each user profile may include a threshold minimum and/or a threshold maximum.

In certain embodiments, the method further includes gathering, by the processor, data during use of the cloud computing system. The method may further include comparing the data to each of the usage data ranges associated with each of the set of attributes. If the data fits within a different user profile, the user profile for the user may be updated. In some embodiments, the learning model may be updated based on the data gathered during use of the cloud computing system by the user.

In some embodiments, during a training phase, the method includes gathering data during use of the cloud computing system from multiple users. The method may use the data to create and update the user profiles. Each user profile may include multiple attributes and at least one of the attributes may include a usage data range.

An apparatus for predictive hardware load balancing includes a processor and a non-transitory computer readable storage media storing code. The code is executable by the processor to perform operations. The operations include receiving a request from a user to access a cloud computing system. The operations further include, in response to the request, associating the user with a user profile via a learning model. The learning model uses machine learning to characterize attributes of the user. The learning model further uses the attributes of the user to determine the user profile of multiple user profiles to associate with the user. Each of the user profiles is associated with a set of attributes and a set of system resources. The operations include allocating system resources to the user based on the user profile. The system resources may include utilization of a CPU, a GPU, an accelerator, an FPGA, ROM storage, RAM storage, and/or an internet connection speed.

In some embodiments, an attribute of the user includes a workload type previously used by the user and the user profile associated with the user includes a user profile correlated with the workload type. In other embodiments, the workload type is input/output (“I/O”) bound, memory bound, and/or central processing unit (“CPU”) bound. In some embodiments, the set of attributes includes usage data associated with a resource, a type of resources used, a length of time the resources are used, and/or a time of day the resources are used. The learning model may be configured to determine a usage data range associated with each of the set of attributes for each user profile.

In some embodiments, the operations further include gathering, by the processor, data during use of the cloud computing system by the user. The operations may further include comparing the data to each of the usage data ranges associated with each of the set of attributes and updating the user profile for the user in response to determining that the data fits within a different user profile. In certain embodiments, the operations include gathering data during use of the cloud computing system by the user and updating the learning model based on the data.

In some embodiments, the operations include, during a training phase, gathering data during use of the cloud computing system from a plurality of users. The data may be used to create and update the plurality of user profiles, where each user profile includes multiple attributes. In some embodiments, one or more of the attributes includes a usage data range for the attribute.

According to a third aspect of the invention, a program product includes a non-transitory computer readable storage medium storing code. The code is configured to be executable by a processor to perform operations. The operations include receiving a request from a user to access a cloud computing system and, in response to the request, associating the user with a user profile via a learning model. The learning model uses machine learning to characterize attributes of the user. The learning model uses the attributes of the user to determine, from multiple user profiles, the user profile to associate with the user. Each of the user profiles may be associated with a set of attributes and a set of system resources. The operations include allocating system resources to the user based on the user profile.

In some embodiments, the set of attributes includes usage data associated with a resource, a type of resources used, a length of time the resources are used, and/or a time of day the resources are used. In certain embodiments, the operations further include gathering data during use of the cloud computing system by the user, comparing the data to each of the usage data ranges associated with each of the set of attributes, and updating the user profile for the user in response to determining that the data fits within a different user profile. In some embodiments, the operations include gathering data during use of the cloud computing system by the user and updating the learning model based on the data.

In some embodiments, the operations include, during a training phase, gathering data during use of the cloud computing system from multiple users. The operations may further include using the data to create and update the plurality of user profiles. Each user profile may include multiple attributes, and one or more of attributes may comprise a usage data range for the attribute.

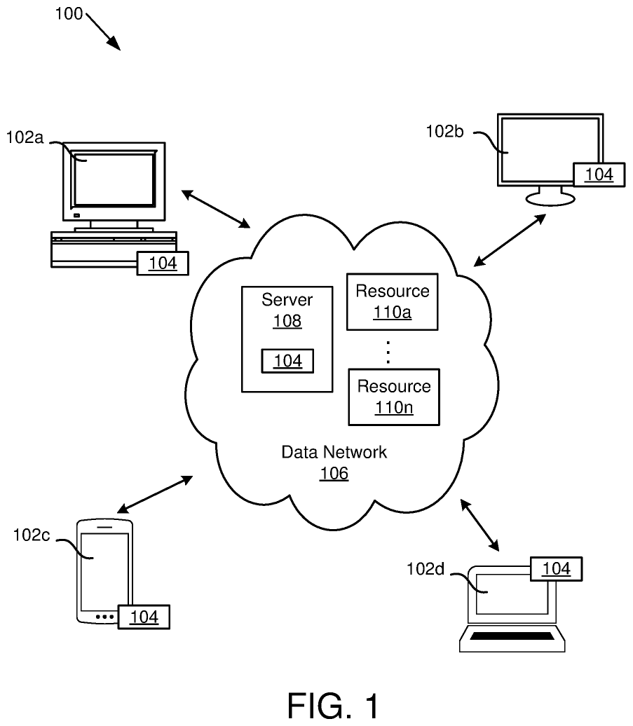

FIG. 1 is a schematic block diagram illustrating a cloud computing system 100 for predictive hardware load balancing, according to various embodiments. FIG. 1 illustrates an operating environment for an apparatus 104 for predictive hardware load balancing, in accordance with various embodiments. In some embodiments, the cloud computing system 100 is a cloud or hybrid computing system that is accessed by one or more computing devices 102a-d (collectively or generically “102”), one or more data networks 106, one or more servers 108, and two or more resources 110a-n. In some embodiments, at least one of the servers 108 in the cloud computing system 100 is a cloud server and at least one of the data networks 106 is a cloud computing network. Although a specific number of computing devices 102a-d, data networks 106, and servers 108 are depicted in FIG. 1, one of skill in the art will recognize that any number of data networks 106, and servers 108 may be included in the cloud computing system 100 and accessed by any number of computing devices 102.

In some embodiments, the cloud computing system 100 is accessed by one or more computing devices 102a-d. The computing devices 102a-d may be embodied as one or more of a desktop computer, a server device, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device that includes a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In general, the server 108 includes a predictive hardware load balancing apparatus 104 configured to utilize predictive analytics to assign system resources to a user in an efficient, reliable manner. In this manner, the predictive hardware load balancing apparatus 104 may enhance the user experience, increase system reliability, and increase operational efficiency. In some embodiments, a portion of the predictive hardware load balancing apparatus 104 may be included in a computing device 102a-d, and/or may be distributed across various computing devices 102a-d, servers 108, and/or other suitable devices. In some examples, the portion of the predictive hardware load balancing apparatus 104 may include an application programming interface (“API”) configured to access the predictive hardware load balancing apparatus 104 on the server 108. In other embodiments, the portion of the predictive hardware load balancing apparatus 104 on the computing devices 102 may include components that access user information to help build a user profile.

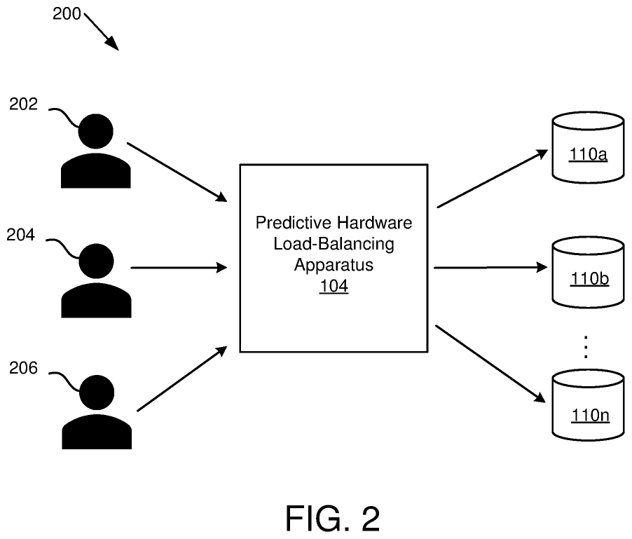

In some embodiments, the predictive hardware load balancing apparatus 104 is configured to receive a request from a user to access the cloud computing system 100, for example, from a computing device 102. The predictive hardware load balancing apparatus 104, in some embodiments, associates the user with a user profile via a learning model. As discussed in more detail with reference to FIG. 2 below, in some embodiments, the learning model is trained to recognize user behaviors with respect to the cloud computing system 100 over time. In some examples, the learning model monitors and collect user behavior over a period of time. In some embodiments, the learning model characterizes user attributes based on the user behavior. The learning model, in some embodiments, groups user attributes together to form a single user profile. User attributes may include, for example, usage data associated with a resource such as workload type, type of resources used, amounts of resources used and/or rates of resource consumption, times of day resources are consumed, duration or length of time resources are consumed, and/or any other suitable data.

In some embodiments, the learning model develops multiple unique user profiles in this manner. Each unique user profile may be associated with a set of attributes and a set of computing system resources 110. In some embodiments, user profiles overlaps with respect to at least a portion of the set of attributes and/or the set of computing system resources 110. In other words, although each user profile may be unique with respect to each other user profile, the set of attributes and the set of computing resources assigned to a user profile may not be entirely unique.

In some embodiments, the learning model of the predictive hardware load balancing apparatus 104 is configured to determine a usage data range corresponding to one or more attributes of a user profile. The usage data range may include a threshold minimum and/or a threshold maximum. In some embodiments, the learning model compares an actual usage data value to the usage data ranges for various user profiles to determine which user profile to associate with the user.

In some embodiments, the learning model determines which user profile of the multiple user profiles to associate with the user based on a percentage or quantity of the user attributes that match attributes of the user profile. For example, in some embodiments, the learning model assigns a user profile to the user in the event that the user attributes match at least ninety-five percent (95%) of the set of attributes for the user profile. In other embodiments, the learning model assigns a user profile to the user in the event that the user attributes match at least eighty percent (80%) of the set of attributes for the user profile. In still other embodiments, the learning model assigns a user profile to the user in the event that the user attributes match more than fifty percent (50%) of the set of attributes for the user profile.

The predictive hardware load balancing apparatus 104, in some embodiments, allocates resources 110a-n (collectively or generically “110”) to the user based on the user profile. The allocated resources 110 may be predefined as a component of the user profile such that resource allocation drives efficiency and reduces costs related to power consumption. In some embodiments, the allocated resources 110 are input to the learning model during a training phase. In certain embodiments, the resources 110 allocated are updated or changed over time. In some embodiments, the resources 110 allocated are changed directly by adjusting learning model inputs during a training or re-training phase. In other embodiments, allocated resources 110 are updated and/or changed as a result of machine learning.

In some embodiments, the predictive hardware load balancing apparatus 104 is distributed over multiple computing devices 102a-d and/or servers 108. Thus, a computing device 102a-d, in some embodiments, is configured to communicate with any number of other computing devices 102a-d and/or servers 108 over any number of data networks 106 to receive a request to access a cloud computing system 100, associate the user with a user profile, and allocate system resources 110 to the user based on the user profile.

In certain embodiments, the predictive hardware load balancing apparatus 104 includes a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. In various embodiments, a hardware appliance of the predictive hardware load balancing apparatus 104 includes a power interface, a wired and/or wireless network interface, a graphical interface that attaches to a display, and/or a semiconductor integrated circuit device as described below, configured to perform the functions described herein with regard to the predictive hardware load balancing apparatus 104.

The predictive hardware load balancing apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In some embodiments, the predictive hardware load balancing apparatus 104 is mounted on a printed circuit board with one or more electrical lines or connections (e.g., to volatile memory, a non-volatile storage medium, a network interface, a peripheral device, a graphical/display interface, or the like). The hardware appliance, in some embodiments, includes one or more pins, pads, or other electrical connections configured to send and receive data (e.g., in communication with one or more electrical lines of a printed circuit board or the like), and one or more hardware circuits and/or other electrical circuits configured to perform various functions of the predictive hardware load balancing apparatus 104.

The semiconductor integrated circuit device or other hardware appliance of the predictive hardware load balancing apparatus 104, in certain embodiments, includes and/or is communicatively coupled to one or more volatile memory media, which may include but is not limited to random access memory (“RAM”), dynamic RAM (“DRAM”), cache, or the like. In some embodiments, the semiconductor integrated circuit device or other hardware appliance of the predictive hardware load balancing apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in some embodiments, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In some embodiments, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in some embodiments, are embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 are communicatively coupled (e.g., networked) over a data network 106 to one or more computing devices 102a-d and may be configured to record, capture, store, or the like measurement data for various components of the server 108 and transmit the measurement data to other devices for processing, analysis, and/or the like.

FIG. 2 is a schematic block diagram illustrating a method 200 for predictive hardware load balancing, according to various embodiments. The predictive hardware load balancing apparatus 104 may include a learning model trained to associate each user with one of various user profiles. In some embodiments, during a training phase, the predictive hardware load balancing apparatus 104 collects and analyzes data from various users 202, 204, 206 over time. The data may include behavioral, operational, and/or usage data pertaining to the cloud computing system 100. The predictive hardware load balancing apparatus 104 may input this data into the learning model to create a set of attributes and a set of system resources 110a-n associated with each user profile. In other embodiments, during a training phase, the learning model of the predictive hardware load balancing apparatus 104 receives direct input including a predefined set of attributes and/or a predefined set of system resources 110a-n associated with each user profile. In still other embodiments, the learning model of the predictive hardware load balancing apparatus 104 receives a combination of direct input and collected behavioral data during a training phase to associate each user profile with a set of attributes and a set of system resources 110a-n.

In some embodiments, during a use phase, the learning model of the predictive hardware load balancing apparatus 104 predictively assigns a user profile to the user 202, 204, 206 based on the user's historical behavior. Historical data may include, for example, types of activity, duration of activity, times of day of activity, workload type, job behavior, resource usage, operating conditions, and/or the like. In some examples, the workload type of a user is a workload type consistently used by the user. Historical data may be captured, measured, sensed, or otherwise collected from one or more of the computing devices 102a-d.

The predictive hardware load balancing apparatus 104, in some embodiments, analyzes the user's historical behavior data to characterize attributes of the user. In some examples, the user attributes is characterized as a gaming user that consumes a large quantity of resources 110a-n primarily during evening hours. In other examples, the user attributes are characterized as a business user that consumes a large amount of resources during working hours. Of course, user attributes may be characterized in any suitable manner and given any suitable designation.

In some embodiments, the predictive hardware load balancing apparatus 104 compares the user attributes to the set of attributes for each of multiple defined user profiles to determine a user profile for the user. In some embodiments, for example, the user profiles may include designations such as “heavy user.” “medium user,” and “light user.” Of course, the disclosure is not limited to any particular number of user profiles and/or user profile designations and contemplates any suitable quantity of user profiles and corresponding descriptive, numerical, alphanumeric, or other suitable user profile designations. In the foregoing example, the user attributes may substantially match the set of attributes for a user profile designated “heavy user.” As a result, the user may be determined to have a user profile designated as “heavy user”.

In certain embodiments, a user profile determined to correspond to a particular user indicates, predicts, forecasts, estimates, or the like, which and how much of various system resources 110a-n the user 202, 204, 206 is likely to consume. Various system resources 110a-n may then be allocated to the user 202, 204, 206 based on these predictions. In some embodiments, the system resources 110a-n include utilization of a CPU, a GPU, an accelerator, an FPGA, ROM storage, RAM storage, an internet connection speed, and/or the like.

In certain embodiments, for example, the “heavy user” user profile includes a predefined allocation set of system resources 110a-n based on predicted heavy use. Similarly, the “medium user” designation and the “light user” designation may include a predefined allocation of system resources 110a-n based on predicted medium use and light use, respectively. The predictive hardware load balancing apparatus 104 may allocate to the user various quantities, types, times of use, duration of use, and other suitable parameters pertaining to the various system resources 110a-n in accordance with the corresponding user profile. In some embodiments, system resources 110a-n associated with each user profile are prioritized based on one or more features such as efficiency, power consumption, and improved user experience, for example.

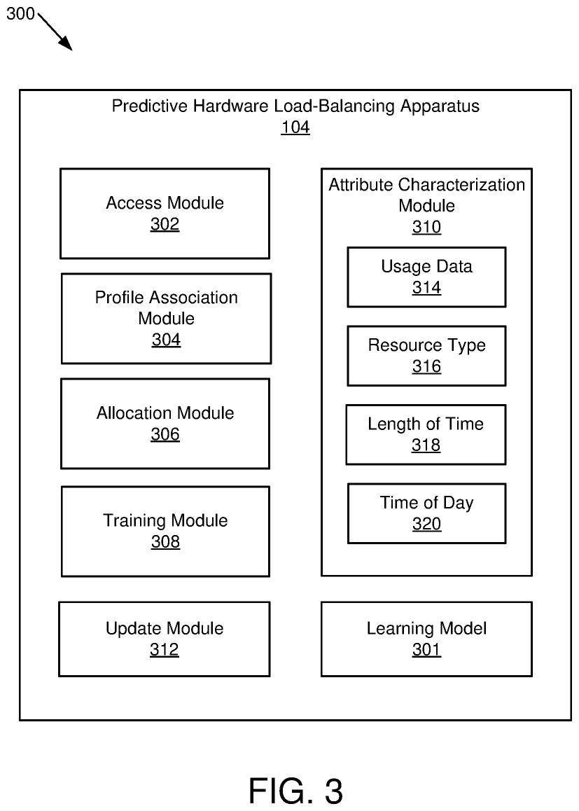

FIG. 3 is a schematic block diagram an apparatus 300 for predictive hardware load balancing, according to various embodiments. The apparatus 300 includes a predictive hardware load balancing apparatus 104 with a learning model 301, an access module 302, a profile association module 304, and an allocation module 306, and in various embodiments a training module 308, an attribute characterization module 310, and an update module 312, which are described below. In various embodiments, the apparatus 300 is implemented with code stored on computer readable storage media. In other embodiments, all or a portion of the apparatus is implemented using hardware circuits and/or a programmable hardware device.

The apparatus 300 includes an access module 302 configured to receive, by a processor, a request from a user to access a cloud computing system 100. In some embodiments, the cloud computing system 100 is a hybrid computing system or other suitable computing system with resources 110 that may be assigned to a user.

In some examples, the request is for execution of a workload, execution of an application, or the like. In some examples, the request is from a client to execute a workload on a virtual machine running on the server 108 and the allocation module 306 allocates resources 110 to the virtual machine. In other embodiments, the request is part of an on-going series of request from a user, such as requests received on a periodic basis, requests received during execution of an application, etc. In some embodiments, the request is received over the data network 106. In some embodiments, the request is part of an initial provisioning of cloud computing resources for a computing device 102.

The apparatus 300 includes a profile association module 304 configured to, in response to the request from the access module 302, associates, using a learning model 301, the user with a user profile. The learning model 301 uses machine learning to characterize attributes of the user and uses the attributes of the user to determine the user profile of a plurality of user profiles to associate with the user. Each of the plurality of user profiles is associated with a set of attributes and a set of system resources 110.

In some embodiments, the apparatus 300 includes an attribute characterization module 310 configured to utilize a learning model 301 to characterize attributes of the user. In some embodiments, the profile association module 304 utilizes the attribute characterization module 310 to correlate user attributes with a user profile. In some embodiments, the attribute characterization module 310 characterizes attributes of the user based on usage/consumption data 314, types of resources used 316, length of time 318 used, time of day 320, and/or other suitable data. The profile association module 304 may determine a user profile to associate with the user based on the user attributes. The user profile may be selected from multiple user profiles, where each user profile is associated with a set of attributes and a set of system resources 110.

The apparatus 300 includes an allocation module 306 configured to allocate system resources to the user based on the corresponding user profile. The allocation module 306, in some embodiments, optimizes efficient allocation of resources based on predictive learning. In addition, in some embodiments, the allocation module 306 further optimizes efficient resource allocation by utilizing the hardware configurations present in the cloud computing system 100 to assign resources 110 to the user based on the proximity of the resources 110 to the user's computing device 102 or access point.

In some embodiments, the apparatus 300 includes a training module 308 configured to train a learning model 301 of the predictive hardware load balancing apparatus 104 to recognize various user behaviors. In some examples, the training module 308 is configured to train the learning model 301 to recognize workload types. An attribute of a user may be a workload type consistently used by a user. The workload types may use different resources, such as those that are I/O bound, memory bound, CPU bound, and/or a combination thereof. In some embodiments, the allocation module 306 allocates resources based on a user profile consistent with a particular workload type. In some embodiments, the training module 308 is configured to input predetermined workload parameters and/or other suitable parameters or features into the learning model 301. In certain embodiments, the training module 308 is configured to collect operational data from the cloud computing system 100 over time. The training module 308 may use machine learning to analyze the input data and/or collected data to generate at least one prediction associated with a user's workload, operational habits, and/or other attributes.

In some embodiments, the training module 308 trains a learning model 301 of the predictive hardware load balancing apparatus 104 on previously collected, captured, saved, or the like, operational data for the cloud computing system 100. For instance, in some embodiments, the training module 308 is configured to train the learning model 301 using behavioral data from a plurality of users of different computing devices 102 where the users submit workloads, execute applications, etc. that access various components, resources 110, etc. that are comparable to the components, resources, etc. of the cloud computing system 100. In some embodiments, the training module 308 utilizes behavioral data collected from a plurality of different computing systems 100 and/or from other users in the same cloud computing system 100 or another cloud computing system 100 that includes the same or substantially similar resources 110.

As used herein, machine learning refers to a device's or system's ability to automatically learn and improve from experience without being explicitly programmed. The learning model 301 uses machine learning. Machine learning focuses on the development of computer programs that can access data and use it to learn for themselves. Various machine learning algorithms are contemplated and may be employed herein, including supervised or unsupervised learning algorithms, neural networks, and/or other deep learning algorithms. The learning model 301 has inputs that include various users, user attributes, workloads, workload attributes, user behaviors, etc.

In some embodiments, a predictive hardware load balancing apparatus 104 includes an update module 312 that utilizes machine learning to update the learning model 301 based on additional data and data analysis acquired after a training phase. The update module 312 may update the learning model 301 on a periodic, intermittent, or continuous basis. Further, the update module 312 may change or adjust one or more of the parameters, features, and/or functions of the learning model 301 as needed. For example, in some embodiments, the update module 312 updates the set of attributes corresponding to one or more of the user profiles. In certain embodiments, the update module 312 adjusts the usage data ranges associated with one or more attributes of one or more user profiles. In these and other embodiments, the update module 312 adjusts the threshold minimum and/or the threshold maximum associated with one or more usage data ranges. In some embodiments, the update module 312 adjusts the allocated resources associated with one or more user profiles.

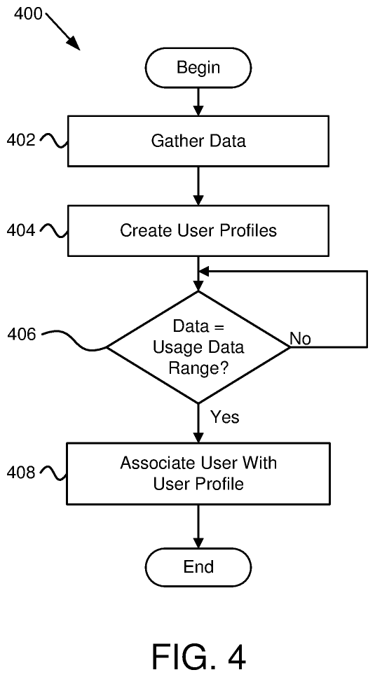

FIG. 4 is a schematic flow chart diagram illustrating a training phase of a method 400 for predictive hardware load balancing, according to various embodiments. The method 400 begins and gathers 402 data from one or more users of a cloud computing system 100. The data may include, for example, behavioral, operational and/or usage data. In some embodiments, the method 400 includes creating 404 multiple user profiles based on the data. Each user profile may include a set of attributes and a set of system resources.

In some embodiments, the set of attributes includes a type of resources used, a length of time the resources are used, a time of day the resources are used, an amount of resources consumed, a rate of consumption, and/or the like. In certain embodiments, a usage data range may be associated with each of the attributes for each user profile. The usage data range for each user profile may include a threshold minimum and/or a threshold maximum.

In some embodiments, the method 400 determines 406 if the user data matches usage data ranges for one or more attributes of a user profile. If the data falls within the usage data range associated with a particular user profile, the method 400 associates 408 the user with the user profile, and the method 400 ends. If the method 400 determines 406 that the user data does not match usage data ranges for a user attribute, the method 400 may continue to compare incoming data to the usage data ranges for various user profiles. In various embodiments, all or a portion of the method 400 is implemented using the access module 302, the profile association module 304, the allocation module 306, the training module 308, the attribute characterization module 310, the update module 312, and/or the learning model 301.

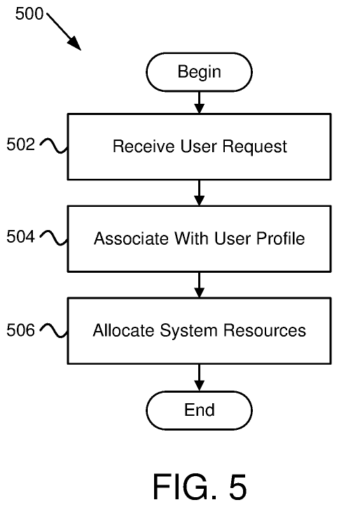

FIG. 5 is a schematic flow chart diagram illustrating a use phase of a method 500 for predictive hardware load balancing, according to various embodiments. The method 500 begins and receives 502, by a processor, a request from a user to access a cloud computing system 100. The method 500, in response to the request, associates 504, using a learning model, the user with a user profile. The learning model uses machine learning to characterize attributes of the user and uses the attributes of the user to determine the user profile of a plurality of user profiles to associate with the user. Each of the plurality of user profiles is associated with a set of attributes and a set of system resources 110.

The method 500 allocates 506 system resources to the user based on the user profile. In some embodiments, the system resources 110 include utilization of a CPU, a GPU, an accelerator, an FPGA, ROM storage, RAM storage, an internet connection speed, and/or the like. In various embodiments, all or a portion of the method 500 is implemented using the access module 302, the profile association module 304, the allocation module 306, the training module 308, the attribute characterization module 310, the update module 312, and/or the learning model 301.

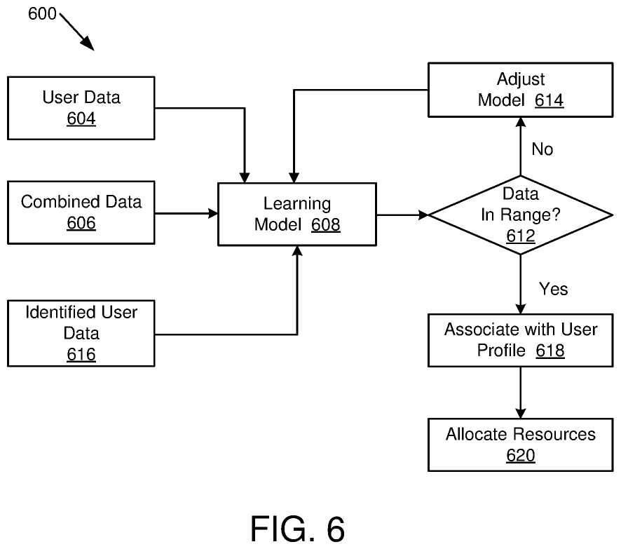

FIG. 6 is a schematic flow chart diagram illustrating a method 600 for predictive hardware load balancing, according to various embodiments. In certain embodiments, an overall method 600 for predictive hardware load balancing includes a training phase and a use phase. During the training phase, the method 600 monitors, collects, and/or analyzes user data 604 and other combined data 606 from a plurality of computer system users. In some embodiments, the user data 604 and the combined data 606 may train a learning model 608 to recognize user behaviors and attributes, such as types of resources used, consumption amounts, consumption rates, times of day resources are used, duration of time resources are used, and the like. Similarly, in some embodiments, the method 600 continuously monitors, collects, and/or analyzes user data 604 from users to identify trends and thereby predict needs for reducing or expanding certain resources, for example.

During the use phase, the method 600 monitors, collects, and/or analyzes user data 616 from an identified user. In some embodiments, the identified user data 616 may also be received by the learning model 608. The learning model 608 may use machine learning to characterize attributes of the user and determine which user profile of various user profiles to associate with the user. Each of the user profiles may be associated with a set of attributes and a set of system resources.

In some embodiments, the identified user data 616 may include a predetermined user profile. User data may be compared 612 to predefined usage data ranges for the user profile. In some embodiments, the predefined usage data ranges may include a threshold minimum and/or a threshold maximum. If the data is not within an expected range for the user profile but fits within a different user profile, the user profile for the user may be updated and/or the learning model may be adjusted 614 in accordance with a machine learning process. For example, in some embodiments, the user submits an additional or different workload which requires consumption of additional resources 110, which results in changed user behavior as reflected by changed user data 616. In these and other embodiments, the data may not be within an expected range for the user profile (e.g., “medium user”), but may fit within the expected range for another user profile (e.g., “heavy user”). User behavior and associated data may be monitored and compared to expected ranges on a continuous or frequent basis, thereby enabling the user profile to be immediately updated to reflect the change. If, on the other hand, the data is within an expected user data range, the user profile may remain associated 618 with the user.

In some embodiments, the method 600 may allocate system resources 620 to the user based on the user profile 618. In some embodiments, the system resources include utilization of at least one of a CPU, a GPU, an accelerator, an FPGA, ROM storage, RAM storage, an internet connection speed, and/or the like. In the event a user profile for a particular user is updated or changed, system resources 620 allocated to the user may be likewise adjusted to optimize system performance and improve user experience.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a processor, a request from a user to access a cloud computing system;
in response to the request, associating, using a learning model, the user with a user profile, wherein the learning model uses machine learning to characterize attributes of the user and uses the attributes of the user to determine the user profile of a plurality of user profiles to associate with the user, each of the plurality of user profiles associated with a set of attributes and a set of system resources; and
allocating system resources to the user based on the user profile.

2. The method of claim 1, wherein the set of attributes comprises usage data associated with a resource, a type of resources used, a length of time the resources are used, and/or a time of day the resources are used.

3. The method of claim 2, wherein the learning model is configured to determine a usage data range associated with each of the set of attributes for each user profile.

4. The method of claim 3, wherein the usage data range for each of the plurality of user profiles comprises a threshold minimum and/or a threshold maximum.

5. The method of claim 4, further comprising:
gathering, by the processor, data during use of the cloud computing system by the user;
comparing the data to each of the usage data ranges associated with each of the set of attributes; and
updating the user profile for the user in response to determining that the data fits within a different user profile.

6. The method of claim 1, further comprising gathering, by the processor, data during use of the cloud computing system by the user and updating the learning model based on the data.

7. The method of claim 1, further comprising, during a training phase:
gathering data during use of the cloud computing system from a plurality of users; and
using the data to create and update the plurality of user profiles, each user profile comprising a plurality of attributes, wherein one or more of the plurality of attributes each comprise a usage data range for the attribute.

8. The method of claim 1, wherein the system resources comprise utilization of at least one of a CPU, a GPU, an accelerator, an FPGA, ROM storage, RAM storage, and an internet connection speed.

9. The method of claim 1, wherein an attribute of the user comprises a workload type previously used by the user and wherein the user profile associated with the user comprises a user profile correlated with the workload type.

10. The method of claim 9, wherein the workload type is input/output (“I/O”) bound, memory bound, and/or central processing unit (“CPU”) bound.

11. An apparatus comprising:
a processor; and
non-transitory computer readable storage media storing code, the code being executable by the processor to perform operations comprising:
receiving a request from a user to access a cloud computing system;
in response to the request, associating the user with a user profile via a learning model, wherein the learning model uses machine learning to characterize attributes of the user and uses the attributes of the user to determine the user profile of a plurality of user profiles to associate with the user, each of the plurality of user profiles associated with a set of attributes and a set of system resources; and
allocating system resources to the user based on the user profile.

12. The apparatus of claim 11, wherein the set of attributes comprises usage data associated with a resource, a type of resources used, a length of time the resources are used, and/or a time of day the resources are used.

13. The apparatus of claim 12, wherein the learning model is configured to determine a usage data range associated with each of the set of attributes for each user profile.

14. The apparatus of claim 11, the operations further comprising:
gathering, by the processor, data during use of the cloud computing system by the user;
comparing the data to each of the usage data ranges associated with each of the set of attributes; and
updating the user profile for the user in response to determining that the data fits within a different user profile.

15. The apparatus of claim 11, the operations further comprising gathering data during use of the cloud computing system by the user and updating the learning model based on the data.

16. The apparatus of claim 11, the operations further comprising:
during a training phase, gathering data during use of the cloud computing system from a plurality of users; and
using the data to create and update the plurality of user profiles, each user profile comprising a plurality of attributes, wherein one or more of the plurality of attributes each comprise a usage data range for the attribute.

17. The apparatus of claim 11, wherein the system resources comprise utilization of at least one of a CPU, a GPU, an accelerator, an FPGA, ROM storage, RAM storage, and an internet connection speed.

18. A program product comprising a non-transitory computer readable storage medium storing code, the code being configured to be executable by a processor to perform operations comprising:
receiving a request from a user to access a cloud computing system;
in response to the request, associating the user with a user profile via a learning model, wherein the learning model uses machine learning to characterize attributes of the user and uses the attributes of the user to determine the user profile of a plurality of user profiles to associate with the user, each of the plurality of user profiles associated with a set of attributes and a set of system resources; and
allocating system resources to the user based on the user profile.

19. The program product of claim 18, wherein the set of attributes comprises usage data associated with a resource, a type of resources used, a length of time the resources are used, and/or a time of day the resources are used.

20. The program product of claim 18, the code further being configured to be executable by a processor to perform operations comprising:
gathering data during use of the cloud computing system by the user;
comparing the data to each of the usage data ranges associated with each of the set of attributes; and
updating the user profile for the user in response to determining that the data fits within a different user profile.
